(19) United States
(12) Patent Application Publication
(10) Pub. No.: US 2005/0235252 A1
(43) Pub. Date: Oct. 20, 2005

(54) System and method for reporting innovation data

(75) Inventor: Erik A. Knight, The Colony, TX (US)

Correspondence Address: BAKER BOTTS L.L.P., 2001 ROSS AVENUE, 6TH FLOOR, DALLAS, TX, 75201, US

(73) Assignee: Electronic Data Systems Corporation

(21) Appl. No.: 10/828,377

(22) Filed: Apr. 20, 2004

(51) Int. Cl. G06F 9/44

(52) U.S. Cl. 717/104

(57) ABSTRACT

A reporting tool for reporting innovation data includes a database and a processor. The database stores innovation data that includes information about the innovation capabilities of an entity. The processor retrieves the innovation data and processes the innovation data according to at least one metric, where metrics represent innovation goals of the entity. A user role is determined, and a report for the entity including the processed innovation data is generated according to the user role.

### RELATED APPLICATION

This application is related to copending U.S. application Ser. No. 10/243,885, “SYSTEM AND METHOD FOR MANAGING INNOVATION CAPABILITIES OF AN ORGANIZATION,” Attorney's Docket 014208.1548 (93-02-009), filed Sep. 13, 2002, by Erik A. Knight.

### TECHNICAL FIELD

This disclosure relates generally to enterprise systems, and more specifically to a system and method for reporting innovation data.

### BACKGROUND

Innovation may be a driving force behind the success of businesses and other organizations. Innovation may allow an organization to discover something new, such as new products, services, or manufacturing processes. The ability to innovate may help to differentiate an organization from its competitors. As a particular example, a software company may require a higher rate of innovation to remain competitive in the software industry. The success of the software company may depend on the company's ability to create new software and upgrades for its customers. It may be difficult, however, for an organization to measure and manage its innovation capabilities.

### SUMMARY

In accordance with the present invention, disadvantages and problems associated with previous techniques for reporting innovation may be reduced or eliminated.

According to one embodiment, a reporting tool for reporting innovation data includes a database and a processor. The database stores innovation data that includes information about the innovation capabilities of an entity. The processor retrieves the innovation data and processes the innovation data according to at least one metric, where metrics represent innovation goals of the entity. A user role is determined, and a report for the entity including the processed innovation data is generated according to the user role.

Certain embodiments of the invention may provide one or more technical advantages. An advantage of one embodiment may be that reporting innovation data may describe the progress of the innovation programs of an organization in comparison with the innovation goals of the organization.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of this disclosure and the advantages thereof, reference is now made to the following descriptions, taken in connection with the accompanying drawings, in which:

FIG. 1 illustrates an example environment for managing innovation capabilities of an organization that incorporates a system for reporting innovation data;

FIG. 2 illustrates an example system for reporting innovation data in accordance with the present invention;

FIG. 3 illustrates an example display for reporting innovation data; and

FIG. 4 illustrates an example method for reporting innovation data in accordance with the present invention.

### DETAILED DESCRIPTION OF EXAMPLE EMBODIMENTS

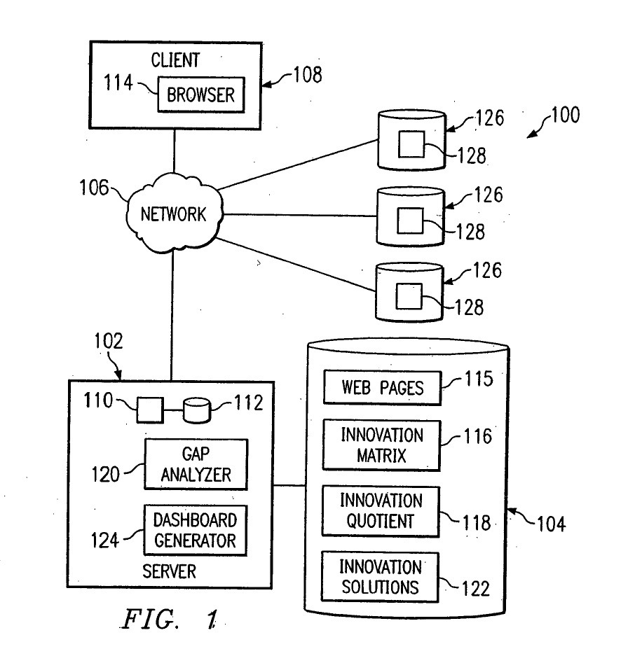

Embodiments of the present invention and its advantages are best understood by referring to FIGS. 1 through 4 of the drawings, like numerals being used for like and corresponding parts of the various drawings.

FIG. 1 illustrates an example environment 100 for managing innovation capabilities of an organization. In the illustrated embodiment, environment 100 includes a server 102, a database 104, a network 106, and a client 108 coupled as illustrated. Other embodiments of environment 100 may be used without departing from the scope of this disclosure.

In one aspect of operation, environment 100 may store and process information related to the innovation capabilities of an organization. Innovation refers to the ability of an organization to create, introduce, employ, or otherwise use something new. The results of the innovation may include, for example, new products or services offered to customers of the organization, new packaging for products offered to customers, or new manufacturing processes used to produce a product. Also, the results of the innovation may represent completely new concepts or ideas, new uses for old ideas, or any other suitable type of result.

The processes, tools, and other mechanisms used by an organization to create, implement, or otherwise support innovation may be referred to as the innovation capabilities of the organization. An organization may have none, several, or many types of innovation capabilities. An example innovation capability may be a research and development program for creating and developing innovative ideas. Another example innovation capability may be the presence of an awards system that rewards employees who file patent applications. Yet another example innovation capability may be the existence of a knowledge base or other repository for knowledge that may be accessed by members of the organization.

The innovation capabilities of an organization may be categorized into categories. For example, the innovation capabilities may include categories such as business processes used by the organization, tools available for use in the organization, financial arrangements, employee programs, and management strategies. Additionally, an organization may utilize the innovation capabilities to support and/or advance innovation programs of the organization. Innovation programs may include any suitable program designed to advance the innovation goals of the organization. For example, a software company may institute one innovation program to develop a new line of software and another innovation program to upgrade an existing line of software products. Innovation programs may be organized in any suitable format and may be tracked individually or as a group depending on the innovation goals of the organization.

Environment 100 may support innovation in an organization by storing quantitative information associated with the innovation capabilities of an organization. Environment 100 may also compare the existing innovation capabilities to a target level of innovation. In addition, environment 100 may measure and display the real-time status of the innovation capabilities to a user, and may be used to customize a display for a particular user. Accordingly, environment 100 may provide a way for an organization to model its current innovation capabilities, identify problems with the innovation capabilities, and monitor how the innovation capabilities vary over time.

In the illustrated embodiment, server 102 is coupled to database 104 and network 106. In this specification, the term “couple” refers to any direct or indirect communication between two or more elements, whether or not those elements are in physical contact with one another. Server 102 performs one or more functions to measure, model, and/or, monitor the innovation capabilities of an organization or a portion of an organization. Server 102 may include any hardware, software, firmware, or any combination thereof operable to perform one or more functions associated with the innovation capabilities of an organization. In this specification, environment 100 may be described as performing functions related to the innovation capabilities of an entire organization. Environment 100 may also perform functions related to the innovation capabilities of portions of an organization, such as for a division of an organization. In addition, while server 102 may be described as performing particular functions, these functions may also be performed manually by a user or other personnel.

In the illustrated example, server 102 includes a processor 110 and a memory 112. Processor 110 executes instructions and manipulates data to perform the operations of server 102. Although FIG. 1 illustrates a single processor 110 in server 102, multiple processors 110 may be used according to particular needs. Memory 112 stores and facilitates retrieval of information used by processor 110 to perform the functions of server 102. Memory 112 may, for example, store instructions to be performed by processor 110 and data used by processor 110. Memory 112 may include any hardware, software, firmware, or combination thereof operable to store and facilitate retrieval of information.

Database 104 is coupled to server 102. Database 104 stores and facilitates retrieval of information used by server 102. For example, database 104 may store information about the innovation capabilities of an organization. This information may be used by server 102 to perform operations in environment 100, such as to identify the real-time innovation capabilities of the organization. Database 104 may include any hardware, software, firmware, or combination thereof operable to store and facilitate retrieval of information. Also, database 104 may use any of a variety of data structures, arrangements, and compilations to store and facilitate retrieval of information.

Network 106 is coupled to server 102 and client 108. Network 106 facilitates communication between components of environment 100. For example, network 106 may communicate Internet Protocol (IP) packets, frame relay frames, Asynchronous Transfer Mode (ATM) cells, or other suitable information between network addresses. Network 106 may include one or more local area networks (LANs), metropolitan area networks (MANs), wide area networks (WANs), all or a portion of a global network such as the Internet, or any other communication system or systems at one or more locations.

Client 108 is coupled to network 106. Client 108 may perform any of a variety of functions in environment 100. For example, client 108 may allow a user to submit information identifying the innovation capabilities of an organization to server 102. Client 108 may also allow the user to submit a request to view the current real-time innovation capabilities of the organization. Client 108 may then display the requested information to the user. Client 108 may include any hardware, software, firmware, or combination thereof operable to communicate with server 102. As a particular example, client 108 may include a web browser 114, which may display information within web pages received from server 102.

In one aspect of operation, database 104 may store and server 102 may process information related to the innovation capabilities of one or more organizations. For example, in the illustrated embodiment, database 104 includes an innovation matrix 116. Innovation matrix 116 stores quantitative information related to the innovation capabilities of an organization. Innovation matrix 116 may store any suitable information identifying the innovation capabilities of an organization. For example, innovation matrix 116 may identify various characteristics of an organization that may be used to support innovation. Possible characteristics may include organizational processes for creating or developing new ideas and financial arrangements for funding these processes. For each characteristic, innovation matrix 116 may include a value identifying how well or how poorly that characteristic supports innovation in the organization.

As a particular example, organizations with lower innovation capabilities may have a low value for a particular characteristic. This might be the case, for example, when the organization is a water utility company. Water utility companies may have little or no need for innovative packaging or products. In contrast, organizations with higher innovation capabilities may have a higher value for that particular characteristic. This may be the case, for example, when the organization is a fashion company. Fashion companies typically require a high level of innovation to remain competitive with one another.

The information included in innovation matrix 116 may be supplied to, generated by, or otherwise made available to environment 100. For example, in one embodiment, the values are made available to server 102 by a user. In this embodiment, during an innovation assessment, the user may analyze the innovation capabilities of an organization with respect to each characteristic of the organization. Based on that assessment, the user may then supply quantitative values to server 102 for storage in innovation matrix 116. In another embodiment, the values in innovation matrix 116 may be generated by server 102. For example, server 102 may make a checklist of various innovation capabilities available to a user, such as through the use of one or more web pages 115. The user may view the web pages 115 and select which innovation capabilities exist in an organization, and server 102 may generate values for innovation matrix 116 based on the user's selection. As a particular example, server 102 may use a weight assigned to each possible innovation capability to give more importance to certain capabilities.

Database 104 may also include one or more innovation quotients 118. An innovation quotient 118 identifies the level of innovation that an organization should have. In one embodiment, innovation quotient 118 may vary depending on the industry in which the organization operates. As a particular example, water utility companies typically need less innovation to remain competitive, while fashion companies typically need more innovation to remain competitive. In this embodiment, innovation quotients 118 may associate various industries with specific level of innovation. The desired level of innovation for a particular organization may be determined using the industry affiliation of the organization, which may be received from a user or identified in any other suitable manner. In another embodiment, the innovation quotient 118 for a particular organization may be directly supplied to database 104 by a user or identified in any other suitable manner.

Information in database 104 may be used by server 102 to model, measure, manage the innovation capabilities of one or more organizations, or any combination of the preceding. In the illustrated example, server 102 includes a gap analyzer 120. Gap analyzer 120 may analyze innovation matrix 116 and innovation quotient 118 for a particular organization. Based on the comparison, gap analyzer 120 may identify any characteristics of the organization where the current innovation capabilities fall behind the desired innovation quotient 118. These organizational characteristics represent areas where the organization may need improvement. Gap analyzer 120 may also identify any characteristics of the organization where the current innovation capabilities exceed the desired innovation quotient 118. These organizational characteristics represent areas where the organization may be spending too much time, money, or other resources on its innovation capabilities. In another embodiment, problems with the innovation capabilities of an organization may be identified in other ways, such as by a user or other personnel, and gap analyzer 120 may be optional in server 102.

Once gaps are found between the desired innovation quotient 118 and the current innovation capabilities of the organization, possible solutions to close the gaps may be identified. For example, database 104 may store innovation solutions 122, which identify different products, services, or processes that might be used to improve or supplement the current innovation capabilities of the organization. In a particular embodiment, innovation solutions 122 are divided according to each organizational characteristic modeled by innovation matrix 116. When the innovation capabilities associated with a particular organizational characteristic fall below the desired innovation quotient 118, gap analyzer 120 may access innovation solutions 122 and identify possible solutions associated with that characteristic. Gap analyzer 120 may then make the identified solutions available to a user or other personnel. In another embodiment, solutions used to resolve problems with the innovation capabilities of an organization may be identified in other ways, such as by a user or other personnel. Gap analyzer 120 may include any hardware, software, firmware, or combination thereof operable to identify problems with and/or analyze data associated with an organization's innovation capabilities. Gap analyzer 120 may, for example, represent one or more software routines executed by processor 110.

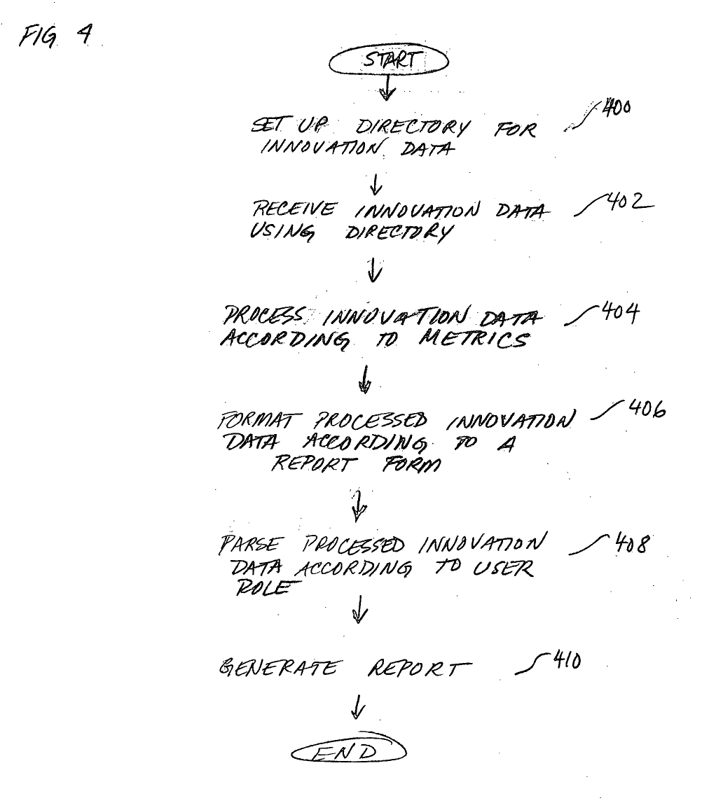

Server 102 also includes a dashboard generator 124. Dashboard generator 124 displays real-time information regarding the innovation capabilities of an organization to a user. For example, dashboard generator 124 may generate a web page showing real-time information about the innovation capabilities of the organization, such as innovation data 128. Innovation data 128 may represent data associated with the innovation capabilities of the organization, such as the number of patent applications filed in the current fiscal year. As particular examples, dashboard generator 124 may generate web pages showing the percentage of money awarded to employees under an invention awards program or the total number of patent applications filed. In a particular embodiment, dashboard generator 124 may create a customized display for a user by displaying specific types of innovation data 128. One example of a display created by dashboard generator 124 is shown in FIG. 3, which is described below. Dashboard generator 124 may use any suitable information to generate the displays for the user. For example, dashboard generator 124 may access data sources 126 maintained by one or more organizations. The data sources 126 may represent databases, repositories, spreadsheets, reporting systems, or other tools supported in environment 100. Dashboard generator 124 may access the data sources 126 over one or more networks 106. Dashboard generator 124 may include any hardware, software, firmware, or combination thereof operable to display information associated with the innovation capabilities of an organization, or to display innovation information to one or more users. Dashboard generator 124 may, for example, represent one or more software routines executed by processor 110. In this specification, the term “each” refers to each of at least a subset of the identified items.

Although FIG. 1 illustrates one example of an environment 100 for managing innovation capabilities of an organization, various changes may be made to environment 100. For example, the functional division of server 102 is used for illustration only. Components of server 102 may be combined or omitted, or additional components may be added according to particular needs. Also, various functions attributed to server 102 may be performed by other components of environment 100 or manually without the use of server 102. As a particular example, in another embodiment, a user may produce the quantitative values stored in innovation matrix 116, identify gaps in the organization's innovation capabilities, and identify possible solutions. In addition, although FIG. 1 illustrates the use of a client-server operating environment, other operational environments may be used.

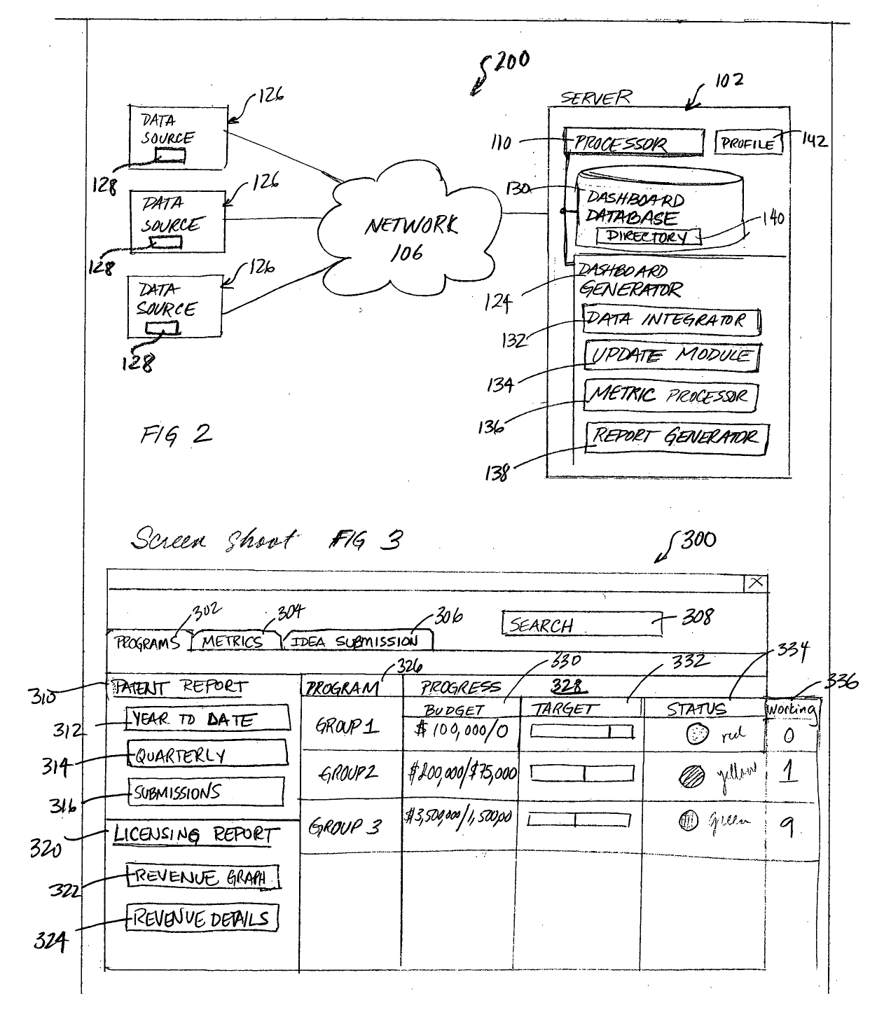

An example system for reporting innovation data in accordance with the present invention is described with reference to FIG. 2. An example display for reporting innovation data using a dashboard generator is described with reference to FIG. 3. An example method for reporting innovation data in accordance with the present invention is described with reference to FIG. 4.

FIG. 2 illustrates an example system 200 for reporting innovation data 128. As was described with reference to FIG. 1, server 102, network 106, and data sources 126 are coupled as shown to allow system 200 to report innovation data 128 using dashboard generator 124. According to the illustrated embodiment, server 102 includes processor 110, a profile 142, a dashboard database 130, and dashboard generator 124.

Profile 142 includes user profiles that allow a user to log into system 200 at a predetermined level of access. According to the illustrated embodiment, profile 142 may include attributes of a user such as access rights to system 200 according to a user role. For example, a low level employee at the organization may be associated with a low level user role that may allow for access to low level reports of innovation data 128. As another example, a high level user such as a vice president of the organization may have a high level user role that may allow for access to detailed reports of innovation data 128. Additionally, a high level user role may enable a corresponding user to input business rules at dashboard generator 124 to customize the display of the reports generated by dashboard generator 124.

Dashboard database 130 is coupled to processor 110 and dashboard generator 124 to provide access to stored innovation data 128 using directory 140. According to one embodiment, directory 140 comprises information about the location of innovation data 128 that processor 110 may use to access innovation data 128. For example, directory 140 may comprise SQL database entries that indicate the location of innovation data 128 at data sources 126. Directory 140 may use any other suitable directory assistance tool without departing from the scope of the invention.

Dashboard database 130 stores innovation data 128. According to one embodiment, dashboard database 130 stores innovation data 128 according to instructions from dashboard generator 124. For example, processor 110 may execute instructions from dashboard generator 124 for the retrieval of innovation data 128 from data sources 126 for subsequent storage at dashboard database 130. Dashboard database 130 may comprise a repository of retrieved innovation data 128 that the organization is interested in tracking. Any other suitable storage medium located at any other module or component of system 200 may be used to store retrieved innovation data 128 without departing from the scope of the invention. Additionally, dashboard database 130 may store any other suitable data without departing from the scope of the invention.

Dashboard generator 124 generates reports associated with the organization using innovation data 128. According to one embodiment, dashboard generator 124 includes one or more executable files that processor 110 may access to retrieve innovation data 128, update innovation data 128, process metrics associated with the organization, and generate reports using innovation data 128. According to the illustrated embodiment, dashboard generator 124 includes a data integrator 32, an update module 134, a metric processor 136, and a report generator 138.

According to one embodiment, data integrator 132 comprises a business logic unit that interacts with dashboard database 130 and processor 110 to retrieve innovation data 128 in real time. Data integrator 132 may include instructions that processor 110 executes to retrieve innovation data 128 from data sources 126. Data integrator 132 may instruct processor 110 to access innovation data 128 as specified by directory 140. For example, data integrator 132 may be executed during setup of dashboard generator 124 to retrieve innovation data 128 that an organization has earmarked for analysis by indicating at directory 140 the location of innovation data 128. In one embodiment, data integrator 132 retrieves innovation data 128 according to the innovation programs of the organization. For example, an organization may track multiple innovation programs. Data integrator 132 may retrieve innovation data 128 corresponding to each innovation program for storage at dashboard database 130.

Update module 134 may be accessed by processor 110 to update innovation data 128. For example, after data integrator 132 stores innovation data 128 at dashboard database 130, update module 134 may periodically access directory 140 to update innovation data 128. Update module 134 may update all or portions of innovation data 128. For example, update module 134 may update only innovation data 128 that has changed since the last update or retrieval. As another example, update module 134 may update only innovation data 128 that is associated with one or more innovation programs. According to one embodiment, update module 134 and data integrator 132 may be integrated in a common business logic unit.

Metric processor 136 may include metrics that measure how innovation data 128 compares with the innovation capabilities of the organization. According to one embodiment, the metrics may include the number of filed patent applications, number of submitted ideas, number of issued patents, budget allocation for development of ideas, amount of money spent in developing ideas, number of identified trade secrets, number of filed trademarks, amount of money spent in employee compensation for idea development, or any other suitable parameter that may be used to measure the innovation capabilities of an organization. Values may be associated with each metric in order for system 100 to track and report how innovation data 128 meets innovation goals. For example, an organization may have a goal of filing 50 patent applications in a given year. The organization may wish to track how many patent applications have been filed on a regular basis and may do so by selecting the metric that corresponds to the number of filed patent applications and associating with the metric a value of 50. The metrics may be selected and combined with other metrics according to any suitable criteria. Any value may be associated with the suitable metrics without departing from the scope of the invention.

Metric processor 136 may process the values of the metrics according to weights. According to one embodiment, a high weight may be assigned to a metric of high importance, while a low weight may be assigned to a metric of low importance. For example, the number of patent applications filed may have high importance or high value, while the number of ideas submitted may have low importance or low value. Any suitable weights or range of weights may be used without departing from the scope of the invention. The values of the metrics may be processed according to the weights. For example, metric processor 136 may multiply the weight and the value of each metric to obtain a raw number for the metric. The raw numbers for all the metrics may be added together to obtain a total raw score, which may be reported as a raw score. Metric processor 136 may normalize the total raw score, standardize the total raw score, compare the total raw scores of business units within the organization, or perform any other suitable processing of the total raw score. Metric processor 136 may include additional modules that may enable a user to input values and weights for each metric.

According to one embodiment, metric processor 136 may generate a status for each innovation program. For example, metric processor 136 may process the metrics associated with an innovation program to determine how the expended efforts associated with the innovation program meet the expectations of the organization according to the metrics. In one embodiment, for example, generating the status of an innovation program may include providing a progress report that may indicate if the innovation program efforts are on target, such as by generating a “fail”, “pass”, and “caution” indicators. The “fail” indicator may represent that the innovation program fails to meet the metrics. The “pass” indicator may represent that the innovation program meets the metrics. The “caution” indicator may represent that the innovation program is neither meeting nor failing the metrics. Metric processor 136 may generate other suitable status indicators to indicate the progress of the innovation programs.

Report generator 138 generates reports using innovation data 128 and the status generated by metric processor 136. According to one embodiment, report generator 138 generates a web-based display to report the innovation programs that the organization is tracking, innovation data 128 for each innovation program, status of each innovation program, and metrics used to generate the report. Report generator 138 may also display a patent report and a licensing report using innovation data 128. An example of a report generated by report generator 138 is described in more detail with reference to FIG. 3.

Report generator 138 receives the status generated by metric processor 136 and displays a progress report for each innovation program. According to one embodiment, report generator 138 receives “pass”, “fail”, and “caution” indicators and displays corresponding “green”, “red”, and “yellow” indicators, respectively. By simplifying the display of the overall progress of each innovation program, a user of system 200 may be able to more efficiently assess where resources may be allocated in order to improve the status of a given innovation program. A user of system 200 may also customize how report generator 138 displays the status. For example, instead of displaying “red”, “green”, and “yellow” indicators, report generator 138 may display the total raw scores of each innovation program, pie charts demonstrating allocated budget versus actual budget for each innovation program, slide bars or percentage numbers indicating the level at which each innovation program satisfies the associated metrics, or any other suitable graphical representation of the status generated by metric processor 136. According to the illustrated embodiment, report generator 138 includes a web-based tool that generates the web-based displays according to the display requirements of the organization.

Report generator 138 may generate reports according to the user role assigned to the user at profile 142. According to one embodiment, report generator 138 may verify the user role in order to provide the appropriate level of access to the user. Report generator 138 may also allow a user to customize the display of the reports. Report generator 138 may allow the user to establish alerts and criteria to determine when a status of an innovation program changes. Additionally, report generator 138 may allow the user having a high level user role to access links to particular data sources 126 that may be restricted to lower level user roles.

Modifications, additions, or omissions may be made to system 200 without departing from the scope of the invention. For example, dashboard generator 124 may include more or fewer modules. As another example, dashboard database 130 may be located anywhere in system 200, for example, at another server or at a data source 126. As yet another example, system 200 may include a client 108 having a browser 114 that enables a user to display a web-based display. As yet another example, report generator 138 may update the reports regularly to ensure that the most current information is displayed using the latest needs of the organization. Additionally, functions may be performed using any suitable logic comprising software, hardware, other logic, or any suitable combination of the preceding.

FIG. 3 illustrates an example display 300 for reporting innovation data 128. In the illustrated example, display 300 includes display tabs 302, 304, and 306 that a user may select to display the information corresponding to each tab. For example, tab 302 may display information corresponding to innovation programs, tab 304 may display information corresponding to metrics, and tab 306 may display information corresponding to idea submissions. Display 300 may include more or fewer tabs and may display the tabs in any other suitable arrangement without departing from the scope of the invention. As a header of display 300, a search box 308 may be provided so that a user may search the content of the web-based display 300. Other suitable information may be provided at the header of display 300.

Programs tab 302 displays information windows that include graphical representations of innovation data 128. In the illustrated example, programs tab 302 includes a patent report panel 310, a licensing report panel 320, and an innovation program panel that reports a progress 328 associated with each innovation program 326. Programs tab 302 may include additional panels and links to display any other suitable information regarding the innovation capabilities of an organization.

Patent report 310 may display reports describing information about the patent portfolio of the organization. According to the illustrated embodiment, patent report 310 may display a year to date report 312, which may illustrate, for example, the number of patent applications filed or patents that have issued in the year to date. A quarterly report 314 may provide information about quarterly activity of the number of patent applications filed or patents issued to date. Submissions report 316 may provide a summary of the number of ideas submitted by employees of the organization. This report may be used to determine the level of involvement of employees of the organization as well as to identify the effectiveness of the incentives provided, if any. Patent report 310 may include more or fewer reports without departing from the scope of the invention. Additionally, patent report 310 may be arranged in any suitable format and may display the information in any suitable graphical representation.

Licensing report 320 includes information regarding the licensing assets of the organization. Licensing report 320 may display links and options to display additional reports related to licensing. In the illustrated example, licensing report 320 includes a revenue graph 322 that may display a graph showing licensing revenue to date, quarterly, monthly, or for any other suitable period. Revenue details 324 may include any information corresponding to the assets the organization is currently licensing or may license in the future. Any other details concerning licensing of assets by an organization may be displayed at licensing report 320 without departing from the scope of the invention. Licensing report 320 may include more or fewer reports and the panel may be arranged in any suitable format and may display the information in any suitable graphical representation.

Program section 326 and progress section 330 display details of the innovation programs of the organization according to innovation data 128. According to the illustrated embodiment, program section 326 lists the innovation programs that an organization wishes to track. As an example, program section 326 lists three innovation programs, Group 1, Group 2, and Group 3. Each innovation program is associated with progress information that may be listed in a summarized format at progress section 330.

According to the illustrated embodiment, progress section 330 includes a budget section 330, a target section 332, a status section 334, and a working section 336. Progress section 330 may include more or fewer sections depending on the type of information to be reported. Progress section 330 may display the values, raw scores, status information, or any combination of the preceding generated by metric processor 136. Status section 334 may include “red”, “green”, and “yellow” indicators corresponding to the “pass”, “fail”, and “caution” states indicators generated by metric processor 136. Target section 332 may include a bar chart, a slide bar, or a pie chart designed to provide a graphical representation of the raw scores generated by metric processor 136. Budget section 330 may include a numerical illustration of the spending budget for the innovation program. For example, Group 1 program is illustrated as having a budget of $100,000 out of which $0 have been spent. Working section 336 may display information about how many ideas, patents, trade secrets, trademarks, or copyrights are being tracked. In another example, working section 336 may also report how many ideas, patents, or trade secrets have been sufficiently developed. In the illustrated example, working section 336 displays that zero patents that have been developed for the Group 1 program, one for the Group 2 program, and nine for the Group 3 program. Progress section 328 may include more or fewer sections that display other suitable progress data associated with the innovation programs listed at program section 326.

Modifications, additions, or omissions may be made to display 300 without departing from the scope of the invention. For example, links to particular data sources 126 may be included if the user accessing the reports is associated with a high level user role. As yet another example, a tab may be included to display customized and standard settings used to generate display 300.

FIG. 4 illustrates an example method for reporting innovation data 128. The method begins at step 400, where directory 140 is set up for innovation data 128. According to one embodiment, location information for innovation data 128 is listed at directory 140. For example, if innovation data 128 includes a spreadsheet that is located at a specific domain, the location information included at directory 140 may include the file name and the specific domain at which the spreadsheet may be found.

At step 402, dashboard generator 124 receives innovation data 128 using directory 140. As was described with reference to FIG. 2, either data integrator 132 or update module 134 may retrieve innovation data 128 for further processing by dashboard generator 124. Additionally, innovation data 128 may be received at dashboard database 130 before being received by dashboard generator 124.

Dashboard generator 124 processes innovation data 128 according to metrics at step 404. According to one embodiment, metric processor 136 processes innovation data 128 using the metrics that have been set up by the user. Processing innovation data 128 may include the evaluation of values associated with each metric and the evaluation of weights that may be associated with each metric. This process may occur for each innovation program that dashboard generator 124 is designed to track or for any other suitable group of information data 128.

The processed innovation data 128 is formatted at step 406 according to a report form. For example, report generator 138 may format the evaluations performed by metric processor 136 and the associated innovation data 128 according to a web-based display format. According to the illustrated embodiment, the processed innovation data 128 is formatted according to a display format shown with reference to FIG. 3.

Processed innovation data 128 may be parsed according to a user role at step 408. As was described with reference to FIG. 2, a user role may be used to determine the level of access to innovation data 128 that a user of system 200 may have. A high level user role may have access to customization tools that a low level user role may not access. Parsing innovation data 128 may include filtering the display to enable or disable links to innovation data 128, data sources 126, or to other reports according to the level of access corresponding to the user role. After parsing innovation data 128, the method proceeds to step 410, where report generator 138 generates a report. According to the illustrated embodiment, the report may include display 300 shown with reference to FIG. 3. After generating the report at step 410, the method terminates.

Steps may be added, omitted, modified, or performed in any suitable order without departing from the scope of the invention. For example, formatting processed innovation data 128 according to a report form at step 406 may be performed substantially simultaneously with parsing processed innovation data according to the user role at step 408. As another example, receiving innovation data 128 at step 402 may modified to be performed at regular intervals such that the report may be generated in real time.

While this disclosure has been described in terms of certain embodiments and generally associated methods, alterations and permutations of the embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

To aid the Patent Office and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are used in the particular claim.

1. A reporting tool for reporting innovation data, comprising:
a database operable to store innovation data, the innovation data comprising information about one or more innovation capabilities of an entity; and
a processor coupled to the database and operable to:
retrieve the innovation data;
process the innovation data according to at least one of a plurality of metrics, the plurality of metrics representing one or more innovation goals corresponding to the entity;
determine a user role; and
generate a report for the entity according to the user role, the report comprising the processed innovation data.

2. The reporting tool of claim 1, the processor further operable to retrieve the innovation data by:
accessing at least one of a plurality of data sources using a directory, the directory indicating the location of at least a portion of the innovation data;
retrieving the at least a portion of the innovation data; and
updating the database with the at least a portion of the innovation data.

3. The reporting tool of claim 1, wherein the plurality of metrics comprises at least one of a budget allocated for innovation, a number of submitted ideas, a number of patent applications, a number of patents issued, a number of acquired trademarks, and a licensing revenue.

4. The reporting tool of claim 1, the processor further operable to process the innovation data according to the at least one of the plurality of metrics by:
identifying the at least one metric associated with an innovation program of the entity;
associating a weight with each of the at least one metric; and
determining a status of the innovation program according to the at least one weight.

5. The reporting tool of claim 1, the processor further operable to generate the report for the entity according to the user role by generating a web-based display that illustrates at least some of the innovation data.

6. The reporting tool of claim 1, wherein the user role is associated with a level of access to the innovation data.

7. A method for reporting innovation data, comprising:
retrieving innovation data, the innovation data comprising information about one or more innovation capabilities of an entity;
processing the innovation data according to at least one of a plurality of metrics, the plurality of metrics representing one or more innovation goals corresponding to the entity;
determining a user role; and
generating a report for the entity according to the user role, the report comprising the processed innovation data.

8. The method of claim 7, wherein retrieving the innovation data comprises:
accessing at least one of a plurality of data sources using a directory, the directory indicating the location of at least a portion of the innovation data;
retrieving the at least a portion of the innovation data; and
updating the database with the at least a portion of the innovation data.

9. The method of claim 7, wherein the plurality of metrics comprises at least one of a budget allocated for innovation, a number of submitted ideas, a number of patent applications, a number of patents issued, a number of acquired trademarks, and a licensing revenue.

10. The method of claim 7, wherein processing the innovation data according to the at least one of the plurality of metrics comprises:
identifying the at least one metric associated with an innovation program of the entity;
associating a weight with each of the at least one metric; and
determining a status of the innovation program according to the at least one weight.

11. The method of claim 7, wherein generating the report for the entity according to the user role comprises generating a web-based display that illustrates at least some of the innovation data.

12. The method of claim 7, wherein the user role is associated with a level of access to the innovation data.

13. Software for reporting innovation data, the software embodied in a computer readable medium and operable to:
retrieve innovation data, the innovation data comprising information about one or more innovation capabilities of an entity;
process the innovation data according to at least one of a plurality of metrics, the plurality of metrics representing one or more innovation goals corresponding to the entity;
determine a user role; and
generate a report for the entity according to the user role, the report comprising the processed innovation data.

14. The software of claim 13, further operable to retrieve the innovation data by:
accessing at least one of a plurality of data sources using a directory, the directory indicating the location of at least a portion of the innovation data;
retrieving the at least a portion of the innovation data; and
updating the database with the at least a portion of the innovation data.

15. The software of claim 13, wherein the plurality of metrics comprises at least one of a budget allocated for innovation, a number of submitted ideas, a number of patent applications, a number of patents issued, a number of acquired trademarks, and a licensing revenue.

16. The software of claim 13, further operable to process the innovation data according to the at least one of the plurality of metrics by:
identifying the at least one metric associated with an innovation program of the entity;
associating a weight with each of the at least one metric; and
determining a status of the innovation program according to the at least one weight.

17. The software of claim 13, further operable to generate the report for the entity according to the user role by generating a web-based display that illustrates at least some of the innovation data.

18. The software of claim 13, wherein the user role is associated with a level of access to the innovation data.

19. A reporting tool for reporting innovation data, comprising:
means for retrieving innovation data, the innovation data comprising information about innovation capabilities of an entity;
means for regularly the innovation data;
means for processing the innovation data according to at least one of a plurality of metrics, the plurality of metrics representing innovation goals corresponding to the entity;
means for determining a user role; and
means for generating a report for the entity according to the user role, the report comprising the processed innovation data.

20. A reporting tool for reporting innovation data, comprising:
a database operable to store innovation data, the innovation data comprising information about one or more innovation capabilities of an entity; and
a processor coupled to the database and operable to:
retrieve the innovation data by:
accessing at least one of a plurality of data sources using a directory, the directory indicating the location of at least a portion of the innovation data;
retrieving the at least a portion of the innovation data; and
updating the database with the at least a portion of the innovation data;
process the innovation data according to at least one of a plurality of metrics, the plurality of metrics representing one or more innovation goals corresponding to the entity, the plurality of metrics comprising at least one of a budget allocated for innovation, a number of submitted ideas, a number of patent applications, a number of patents issued, a number of acquired trademarks, and a licensing revenue, the innovation data processed according to the at least one of the plurality of metrics by:
identifying the at least one metric associated with an innovation program of the entity;
associating a weight with each of the at least one metric; and
determining a status of the innovation program according to the at least one weight;
determine a user role, the user role associated with a level of access to the innovation data; and
generate a report for the entity according to the user role, the report comprising the processed innovation data, the report generated for the entity according to the user role by generating a web-based display that illustrates at least some of the innovation data.
